(19) United States
(12) Patent Application Publication
(10) Pub. No.: US 2005/0113174 A1
(43) Pub. Date: May 26, 2005

(54) Gaming machine

(75) Inventor: Takashi Izawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Tokyo (JP)

(21) Appl. No.: 10/960,205

(22) Filed: Oct. 8, 2004

(30) Foreign Application Priority Data
Oct. 8, 2003 (JP) 2003-349899
Sep. 24, 2004 (JP) 2004-276891

(51) Int. Cl. A63F 13/00

(52) U.S. Cl. 463/46

(57) ABSTRACT

A gaming machine of the present invention has a cabinet for housing a gaming unit required for playing a game, a mounting table provided in a housing part for the gaming unit in the cabinet, and an open/close door capable of closing an opening part of the housing part and placed in an upward slant form. The mounting table has such a downward slant structure that it is lower on a back side thereof than on the opening part side.

### CROSS REFERENCE TO RELATED APPLICATIONS

This application is based upon and claims the benefit of priority from the prior Japanese Patent Application Laid-open No. 2003-349899, filed on Oct. 8, 2003; 2004-276891, filed on Sep. 24, 2004 the entire contents of which are incorporated herein by reference.

### BACKGROUND OF THE INVENTION

1. Field of the Invention

The present invention relates to a gaming machine on which a player can play various kinds of games while sitting.

2. Related Background Art

Conventionally, a variety of gaming machines on which various games can be played have been known. Examples of a slot machine that is known as one kind of the gaming machines include well-known two types as follows: one is a slot machine having a variable display device in which a plurality of mechanical reels each for displaying a plurality of symbols are arranged (also referred to as a reel unit); and the other is a slot machine having an image display device for displaying variable display images of a plurality of symbols as if mechanical reels are rotating (a so-called video slot machine). In addition, in the former type of slot machine, an image display device for mainly displaying a performance image may be placed on the front face of the mechanical reels.

On the other hand, in a conventional gaming machine, a device required for playing games (hereinafter, referred to as a “gaming unit”) such as a variable display device or an image display device is incorporated in a cabinet. Depending on the difference in structure of the cabinet, gaming machines are classified into a type on which a player plays a game while sitting (a so-called slant-type, see, for example, Japanese Patent Application Laid-open No. 2003-67810: Patent Document 1) and a type on which a player plays a game while standing (a so-called upright-type, see, for example, Japanese Patent Application Laid-open No. 2001-198265: Patent Document 2).

Incidentally, in the gaming machine, the gaming unit such as a variable display device or an image display device is incorporated in the cabinet such that it is visible by the player and its operation becomes stabilized. For example, a reel unit is typically incorporated in the cabinet of a slot machine, and the reel unit of the upright-type slot machine is mounted on, in a manner to be attachable to/detachable from, a mounting table (also referred to as a middle board) which is provided such as to divide the inside of the cabinet into two, that is, top and bottom parts and substantially horizontally placed.

### SUMMARY OF THE INVENTION

Different from the upright-type, the slant-type gaming machine, however, has the following problems.

In the slant-type gaming machine, the gaming unit is placed at a position where the player can look it down from the above while sitting on a chair or the like. For example, as a gaming machine disclosed in Patent Document 1, a visible part for the player to view the gaming unit is placed in an upward slant form such that it falls backward on the upper side and thus rises from the front side to the rear side so as to give the player better viewing.

Further, in this kind of gaming machine, the visible part viewed by the player has an openable/closable structure by means of a door which is freely opened/closed (an open/close door), so that when this open/close door is opened, a housing part for the gaming unit appears so that the gaming unit can be taken in/out. More specifically, the gaming machine has a slant opening part which is provided inside the open/close door and slants similarly to the open/close door so that the gaming unit can be taken in/out of the housing part on the back side through the opening part to thereby perform an attachment/detachment operation of the gaming unit to/from the mounting table.

Incidentally, there is a problem that if the mounting table is horizontally installed despite the opening part has an upward slant form, the size of the housing part which can be effectively utilized is decreased, leading to a difficulty in performance of the attachment/detachment operation of the gaming unit.

When taking in/out the gaming unit for the attachment/detachment operation, an operator tends to move the gaming unit in a direction along the mounting table. Therefore, for example, when opening an open/close door 99 and performing the attachment/detachment operation of the gaming unit through an opening part 100 having a height H10 as shown in FIG. 6, the operator moves the gaming unit in a direction of an arrow f in the drawing, and therefore only an apparent height h10 (a shortest distance from the opening part 100 to a mounting table 102) as seen from the front side of the height H10 can be effectively used. In other words, even through the height H10 of the opening part 100 is usually set to a size corresponding to the height of the gaming unit, the mounting table 102 interferes in performing the attachment/detachment operation of the gaming unit, whereby the height H10 cannot be sufficiently utilized, presenting a problem that the gaming unit is difficult to take in/out.

The present invention has been developed to solve the above-described problem, and its object is to make it possible to easily take in/out a gaming unit such as a reel unit to thereby easily perform an attachment/detachment operation in a slant-type gaming machine.

To achieve the above object, the present invention is a gaming machine including a cabinet for housing a gaming unit required for playing a game, a mounting table provided in a housing part for the gaming unit in the cabinet, and an open/close door capable of closing an opening part of the housing part and placed in an upward slant form, which is characterized in that the mounting table has such a downward slant structure that the mounting table is lower on a back side thereof than on the opening part side.

In this gaming machine, a large space can be secured above the mounting table in the housing part since the mounting table has the downward slant structure.

Further, it is preferable that in the above-described gaming machine, an open angle formed between the open/close door in a closed state closing the opening part and the mounting table is set to almost 90 degrees.

Furthermore, it is suitable that the mounting table is placed such that a shortest distance from the opening part thereto is larger than a height of the gaming unit.

The present invention will be more fully understood from the detailed description given herein below and the accompanying drawings which are given by way of illustration only, and thus are not to be considered as limiting the present invention.

### BRIEF DESCRIPTION OF THE DRAWINGS

FIG. 1 is a perspective view showing the entire configuration of a slot machine according to the present embodiment;

FIG. 2 is a perspective view of the slot machine shown in FIG. 1 showing a state in which its open/close door is opened;

FIG. 3 is a side view showing a state in which the open/close door is opened and a reel unit is being incorporated into a cabinet;

FIG. 4 is a perspective view of the reel unit and a mounting table seen from the back side of the slot machine;

FIG. 5 is a side view showing a closed state of the open/close door of the slot machine shown in FIG. 1; and

FIG. 6 is a perspective view showing a slant-type gaming machine with a mounting table formed in a horizontal direction.

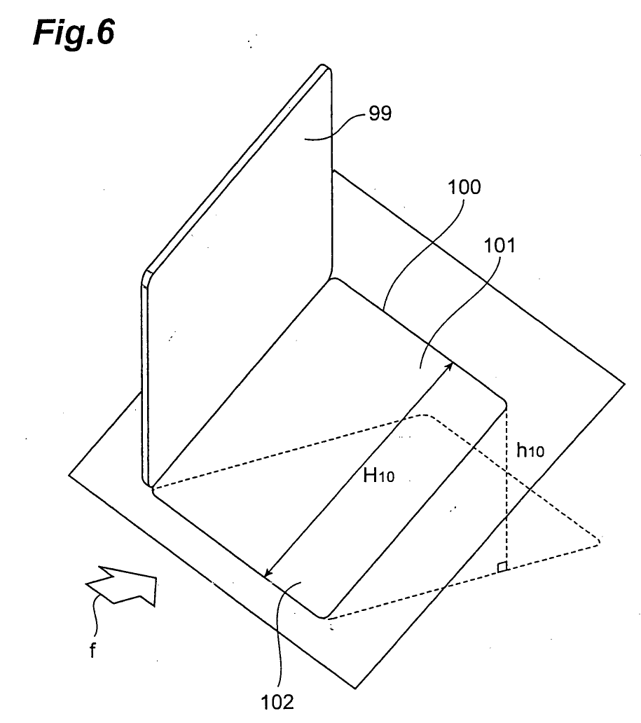

### DESCRIPTION OF THE PREFERRED EMBODIMENTS

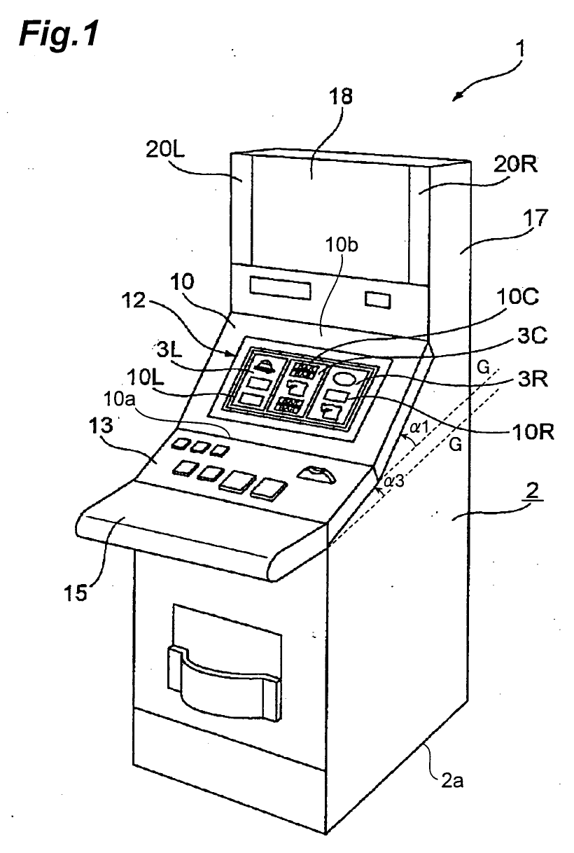

A preferred embodiment of a gaming machine according to the present invention will be described below in detail with reference to FIG. 1 to FIG. 5 taking a slant-type slot machine as an example. Note that the same reference numbers are used for the same components and overlapping description thereof is omitted.

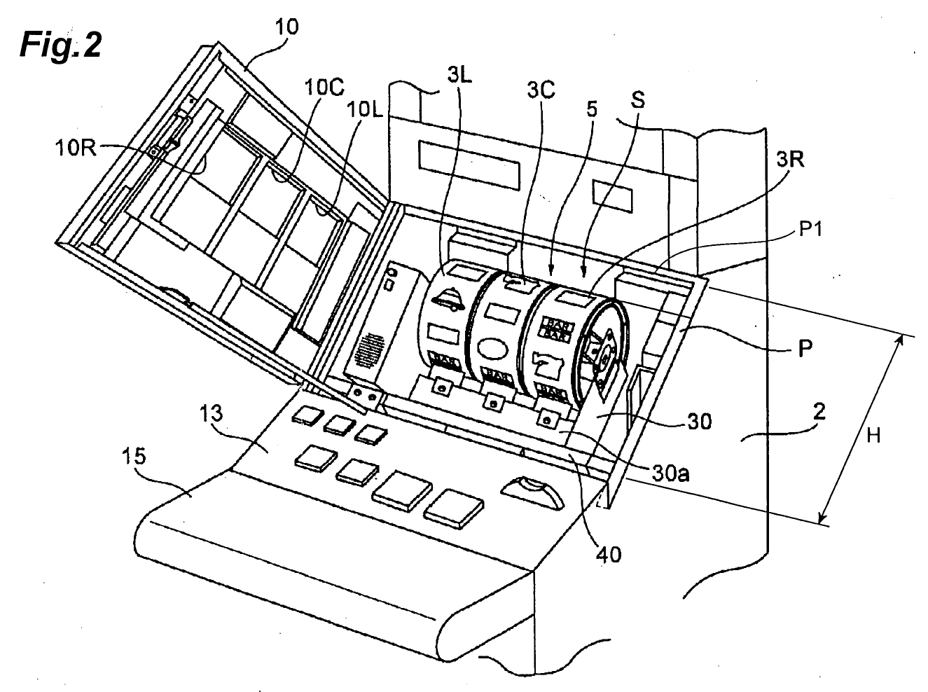

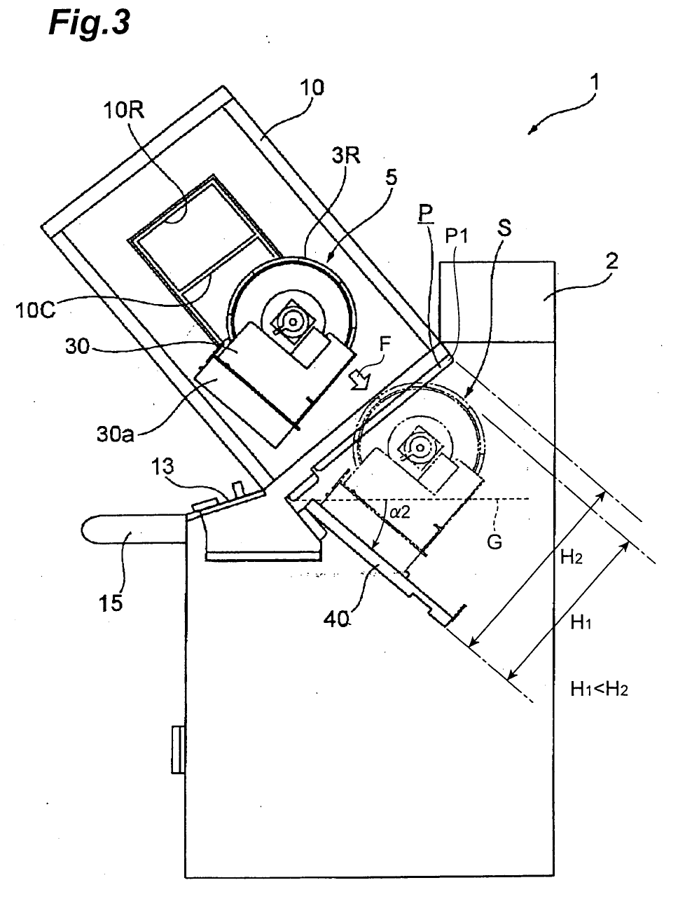

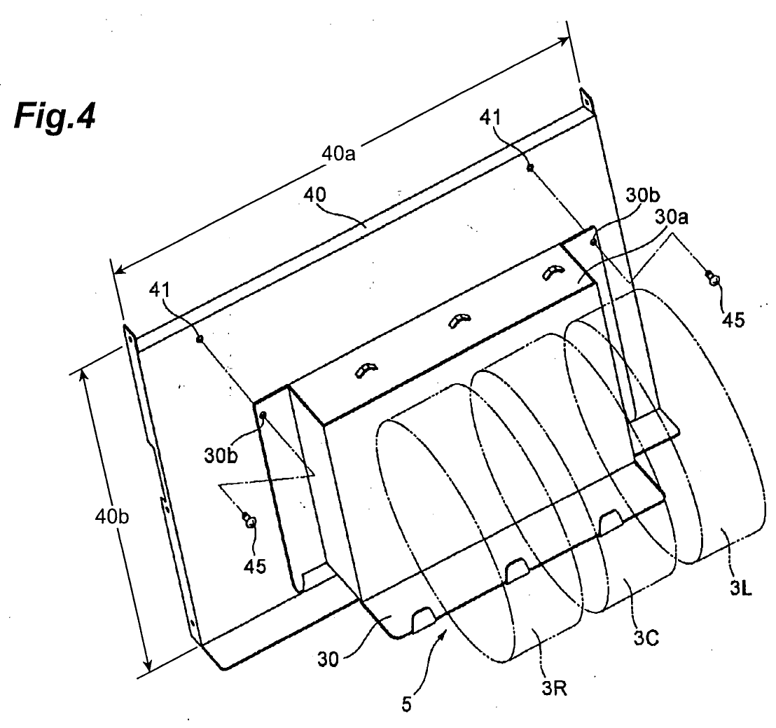

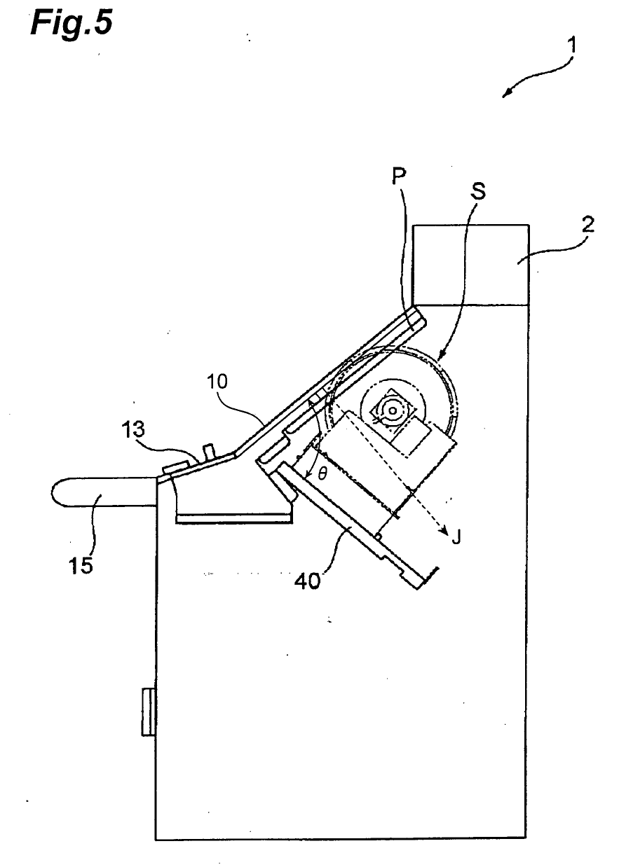

FIG. 1 is a perspective view showing the entire configuration of a slot machine 1 according to the present embodiment, and FIG. 2 is a perspective view of the slot machine 1 showing a state in which its open/close door 10 is opened. FIG. 3 is a side view showing a state in which the open/close door is opened and a reel unit is being incorporated into a cabinet, and FIG. 4 is a perspective view of the reel unit and a mounting table seen from the back side of the slot machine. Further, FIG. 5 is a side view showing a closed state of the open/close door of the slot machine shown in FIG. 1.

The slot machine 1 has a cabinet 2 and the open/close door 10 at a position on the slightly upper side of the middle in the vertical direction of the cabinet 2. Further, the slot machine 1 has a housing part S on the back side of an opening part P corresponding to the open/close door 10 inside the cabinet 2, and a reel unit 5 (a gaming unit in the present invention) is incorporated in the housing part S. The reel unit 5 comprises three mechanical reels 3L, 3C, and 3R arranged side by side in a line to be rotatable, on each of which symbols are drawn.

The open/close door 10 has a size capable of closing the opening part P of the housing part S, and is placed at a position where a player (not shown) can look down the door 10 from the above while sitting on the front side of the slot machine 1. Further, the open/close door 10 has three vertically long window parts 10L, 10C, and 10R at a substantially middle part thereof so that the reels 3L, 3C, and 3R can be viewed from the outside through the respective window parts 10L, 10C, and 10R.

In addition, the open/close door 10 is placed in an upward slant form such that it falls backward on the upper side and thus rises from a front side end portion 10a to a rear side end portion 10b to allow the reels 3L, 3C, and 3R to be easily viewed. In other words, the open/close door 10 has such an upward slant structure that it slants at a slant angle of a 1 (0<α1<90°) from a reference line G indicating a direction along a bottom portion 2a of the cabinet 2 (a horizontal direction). In the slot machine 1 in the present embodiment, the slant angle α1 is set to a range of about 40°±10°. This is for the player to look the reel unit 5 through the open/close door 10 with ease, and in consideration of the visible angle of a later-described liquid crystal display device 12.

Furthermore, as shown in FIG. 2, the open/close door 10 is configured to open/close in the width direction (the right-left direction) with its left end portion as seen from the front used as a shaft, so that when the open/close door 10 is opened, the opening part P having a slant structure similar to that of the open/close door 10 appears.

The housing part S is a space larger than the reel unit 5 in both breadth and height and is provided inside starting from the opening part P along a direction of a later-described straight line J of the open/close door 10 as shown in FIG. 5. Further, to the housing part S, a mounting table 40 is secured on the side of a later-described base portion 13.

The mounting table 40 is, as shown in FIG. 4, a member in a shape of a generally flat plate having a width 40a corresponding to the breadth of the housing part S and a height 40b corresponding to the depth thereof and has such a downward slant structure that it is lower on the back side than on the opening part P side as shown in FIG. 3 and FIG. 5. In other words, the mounting table 40 has a slant structure in which it slants at a slant angle of α2 (−90°<α2<0) from the reference line G.

Further, the mounting table 40 has such a crossing structure that it is placed in a direction substantially intersecting with the open/close door 10 in a closed state closing the opening part P. In FIG. 5, the mounting table 40 is placed in a manner not to cross, in the housing part S, the straight line J extending in a crossing direction substantially intersecting with the open/close door 10. Incidentally, when a later-described open angle θ is decreased, the mounting table 40 may cross the straight line J. Further, as shown in FIG. 3, the slant angle α2 of the mounting table 40 is set such that a shortest distance H2 from an edge portion P1 on the back side of the opening part P (a length of a perpendicular line from the edge portion P1 to a plane including the mounting table 40) is larger than a height H1 of the reel unit 5 (H2>H1). Note that the mounting table 40 has a configuration in the form of a flat plate in consideration of stability of the reel unit 5 to be mounted thereon.

On the other hand, the cabinet 2 has the base portion 13 having a slant face gentler than the open/close door 10 (a slant angle α3, 0<α3<α1) below the open/close door 10. On the base portion 13, various kinds of control members required for playing games (various kinds of buttons such as a BET button, a reel rotation button, a reel stop button, an insertion slot into which coins are inserted, and so on) are arranged.

Further, the slot machine 1 is provided with an armrest 15 including a flat surface extending in a substantially horizontal direction on the front side of the base portion 13. Provision of the armrest 15 allows the player in operating the various kinds of control members on the base portion 13 to perform operation with his or her arms and wrists rested thereon while sitting on a not-shown chair or the like.

On the other hand, the cabinet 2 comprises two side panel portions 17 vertically standing from the bottom portion 2a on the rear side of the open/close door 10. Besides, above the open/close door 10 and between the side panel portions 17, provided are, for example, a payout table 18 displaying information on games such as combinations of prize symbols and payout amount, and speakers 20L and 20R which generate effective performance sound to increase amusement in game during play of a game, and so on.

Further, the slot machine 1 has a transmissive type liquid crystal display device 12 as a device for increasing the amusement in games. The liquid crystal display device 12 is provided on the open/close door 10. The liquid crystal display device 12 comprises a protective glass, a display plate, a liquid crystal panel, a light guide plate, a reflective film, a fluorescent lamp, a table carrier package (TCP) loaded with an IC for driving the liquid crystal panel, and so on, to perform transmissive display within a region corresponding to the window parts 10L, 10C, and 10R so that the reels 3L, 3C, and 3R can be viewed. For example, the liquid crystal display device 12 displays various kinds of moving performance images, information required for the player to carry on the game, and so on according to the game.

The reel unit 5 rotatably supports each of the reels 3L, 3C, and 3R as shown in FIGS. 2 and 4 at regular intervals, and has a flame 30 which holds not-shown various kinds of components. The reel unit 5 has a stepping motor for rotating each of the reels 3L, 3C, and 3R, an illumination unit for illuminating each of the reels 3L, 3C, and 3R with light, a sensor for detecting the position of each of the reels 3L, 3C, and 3R, and so on through use of the flame 30, so that the reel unit 5 has an integrated structure in which those components are held on the flam 30.

The flame 30 has a base portion 30a. The base portion 30a has a size smaller than that of the mounting table 40 in both width and depth so as to be able to be mounted on the mounting table 40.

As described above, the slot machine 1 has the mounting table 40 placed inside the housing part S such that the mounting table 40 is in a downward slant form, so that a large space can be secured above the mounting table 40 in the housing part S. Accordingly, the large space above the mounting table 40 can be utilized when the reel unit 5 is moved along the mounting table 40, which enables the reel unit 5 to be easily taken in/out.

In addition, placement of the mounting table 40 in the downward slant form enlarges the angle formed between the open/close door 10 and the mounting table 40 (hereinafter, referred to as an “open angle”), so that when taking in/out the reel unit 5 through the opening part P to perform attachment/detachment operation, an operator can take substantially full advantage of the height H of the opening part P as it is. Further, the shortest distance H2 from the edge portion P1 on the back side of the opening part P thereto is designed to be larger than the height H1 of the reel unit 5, preventing the reel unit 5 from bumping into the opening part P and the mounting table 40 from interfering with the attachment/detachment operation of the reel unit 5.

As described above, in the slot machine 1, the operator can utilize the height H of the opening part P to the almost full extent when moving the reel unit 5 along the mounting table 40 in a direction shown by an arrow F in FIG. 3, and thus can easily carry out the attachment/detachment operation of the reel unit 5.

In consideration of ease of mounting and removal of the reel unit 5 to/from the mounting table 40, it is desirable to place the mounting table 40 such that an open angle θ is almost 90 degrees (the open/close door 10 substantially intersects with the mounting table 40) as shown in FIG. 5. Incidentally, the reel unit 5 is generally formed to be somewhat smaller in size than the opening part P, and the operator generally performs the attachment/detachment operation of the reel unit 5 along the mounting table 40, and therefore the open angle θ can be changed as long as the angle falls within a range at which workability does not deteriorate (on the order of 90°±30°).

There are various methods for mounting the reel unit 5 on the mounting table 40. For example, as shown in FIG. 4, a plurality of screw holes 41 are formed in the mounting table 40, a plurality of screw insertion holes 30b are formed in the base portion 30a of the reel unit 5 to correspond to the screw holes 41 so that screws 45 are fitted in with the screw insertion holes 30b in the base portion 30a aligned with the screw holes 41 in the mounting table 40 to screw the reel unit 5 on the mounting table 40, to thereby secure and hold the reel unit 5 on the mounting table 40. Alternatively, an engagement member such as a hook may be formed on the base portion 30a and used to engage the reel unit 5 to the mounting table 40. Alternatively, depending on the shape of the flame 30 of the reel unit 5, the flame may be abutted against a not-shown abutting portion formed on the mounting table 40 or in the cabinet 2 to stabilize the holding state thereof.

Although the embodiment of the gaming machine according to the present invention has been described above, the present invention is not limited to the above-described embodiment, but can be configured as described below, for example.

In the above-described embodiment, the open/close door 10 is configured to open in the width direction. The open/close door 10, however, may be configured to open in a top-down direction. Further, the cabinet 2 is only an example of the cabinet in the present invention, and therefore it may have any other shapes and location of each component is not limited to the above description. Moreover, the method for mounting the reel unit 5 on the mounting table 40 and the shape of the flame 30 and the shape of the mounting table 40 can be variously embodied as long as the gist of the present invention is not changed.

While the description is presented by taking the example of the slant-type slot machine as an example, the present invention is also applicable to other slant-type gaming machines of which the gaming unit can be attached/detached by opening/closing the open/close door.

According to the present invention, a slant-type gaming machine can be obtained in which an attachment/detachment operation of the gaming unit can be performed sufficiently utilizing the height of its opening part, so that the attachment/detachment operation of the gaming unit can be easily performed.

It is apparent that various embodiments and modifications of the present invention can be embodied, based on the above description. Accordingly, it is possible to carry out the present invention in the other modes than the above best mode, within the following scope of claims and the scope of equivalents.

1. A gaming machine comprising a cabinet for housing a gaming unit required for playing a game, a mounting table provided in a housing part for said gaming unit in said cabinet, and an open/close door capable of closing an opening part of said housing part and placed in an upward slant form, wherein
said mounting table has such a downward slant structure that said mounting table is lower on a back side thereof than on said opening part side.

2. The gaming machine according to claim 1, wherein an open angle formed between said open/close door in a closed state closing said opening part and said mounting table is set to almost 90 degrees.

3. The gaming machine according to claim 1, wherein said mounting table is placed such that a shortest distance from said opening part thereto is larger than a height of said gaming unit.
